(19) United States
(12) Patent Application Publication
(10) Pub. No.: US 2022/0087902 A1
(43) Pub. Date: Mar. 24, 2022

(54) Cannula for Vial Adapter

(71) Applicant: Becton, Dickinson and Company, Franklin Lakes, NJ (US)

(72) Inventor: Pei-Ying Hsieh, Hillsdale, NJ (US)

(21) Appl. No.: 17/030,049

(22) Filed: Sep. 23, 2020

(51) Int. Cl. A61J 1/20

(52) U.S. Cl. CPC A61J 1/2096; A61J 1/2068; A61J 1/201; A61J 1/2044

(57) ABSTRACT

A cannula for a vial adapter, having a pressure equalization device, includes a body having a first end, a second end positioned opposite the first end, and a sidewall extending between the first end and the second end. The body defines a central passageway extending from the first end to the second end of the body, with the body defining an opening extending through the sidewall of the body. The opening is in fluid communication with the central passageway. The second end of the body is closed.

### BACKGROUND OF THE INVENTION

### Field of the Disclosure

The present disclosure relates generally to a cannula and, more specifically, a cannula for a vial adapter.

### Description of the Related Art

Health care providers reconstituting, transporting, and administering hazardous drugs, such as cancer treatments, can put health care providers at risk of exposure to these medications and present a hazard in the health care environment. Unintentional chemotherapy exposure can affect the nervous system, impair the reproductive system, and bring an increased risk of developing blood cancers in the future. Some drugs must be dissolved or diluted before they are administered, which involves transferring a solvent from one container to a sealed vial containing the drug in powder or liquid form, by means of a needle. Drugs may be inadvertently released into the atmosphere in gas form or by way of aerosolization, during the withdrawal of the needle from the vial and while the needle is inside the vial if any pressure differential between the interior of the vial and the surrounding atmosphere exists. In order to reduce the risk of health care providers being exposed to toxic drugs, the transfer of these drugs is accomplished utilizing a closed system transfer device or system.

Closed system transfer devices or systems may utilize membranes to ensure the safe transfer of fluid between components. For example, a syringe adapter may include a membrane that contacts a membrane of a mating component, such as a patient connector, IV bag spike, or vial adapter. Piercing of the membranes with a needle can cause the tip of the needle to release particles from the membrane, which is called “coring”. The cores or particles of the membrane can be carried by the needle and contaminate the medicament transported by the needle. The particles of the membrane can also interfere with the operation of one or more components of the system. For example, vial adapters include a pressure equalization device to prevent any pressure differential between the interior of the vial and the surrounding atmosphere, as noted above. Cores or particles of the membrane can block a vent passageway of a pressure equalization device, which may cause pressure to build within the vial leading to leakage of hazardous drugs to the ambient environment.

### SUMMARY OF THE INVENTION

In one aspect or embodiment, a cannula for a vial adapter having a pressure equalization device includes a body having a first end, a second end positioned opposite the first end, and a sidewall extending between the first end and the second end, with the body defining a central passageway extending from the first end to the second end of the body, and the body defining an opening extending through the sidewall of the body. The opening is in fluid communication with the central passageway. The second end of the body is closed.

The opening may be a plurality of openings. The plurality of openings may be arranged in a pattern. The plurality of openings may be arranged in columns and rows. The opening may be circular. The second end of the body may include a piercing tip configured to pierce a stopper of a vial. The second end of the body may be beveled.

In a further aspect or embodiment, a vial adapter includes a body comprising a vent passageway, a pressure equalization device in fluid communication with the vent passageway, and the cannula of any of the aspects or embodiments discussed above, where the opening and the central passageway of the cannula is in fluid communication with the vent passageway and the pressure equalization device.

The vial adapter may include a syringe connection at a first end of the body, with the syringe connection configured to be secured to a syringe adapter. The vail adapter may include a vial connection at a second end of the body, with the vial connection configured to be secured to a vial. The body may define a fluid passageway. The vial adapter may include a membrane covering an end of the fluid passageway.

### BRIEF DESCRIPTION OF THE DRAWINGS

The above-mentioned and other features and advantages of this disclosure, and the manner of attaining them, will become more apparent and the disclosure itself will be better understood by reference to the following descriptions of aspects of the disclosure taken in conjunction with the accompanying drawings, wherein:

FIG. 1 is a front view of a conventional vial adapter, showing the vial adapter attached to a vial.

FIG. 2 is a cross-sectional view of the conventional vial adapter of FIG. 1.

FIG. 3 is a perspective view of a cannula according to one aspect or embodiment of the present application.

FIG. 4 is a cross-sectional view of the cannula of FIG. 3.

Corresponding reference characters indicate corresponding parts throughout the several views. The exemplifications set out herein illustrate exemplary aspects of the disclosure, and such exemplifications are not to be construed as limiting the scope of the disclosure in any manner.

### DETAILED DESCRIPTION

The following description is provided to enable those skilled in the art to make and use the described aspects contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

For purposes of the description hereinafter, the terms “upper”, “lower”, “right”, “left”, “vertical”, “horizontal”, “top”, “bottom”, “lateral”, “longitudinal”, and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following specification, are simply exemplary aspects of the invention. Hence, specific dimensions and other physical characteristics related to the aspects disclosed herein are not to be considered as limiting.

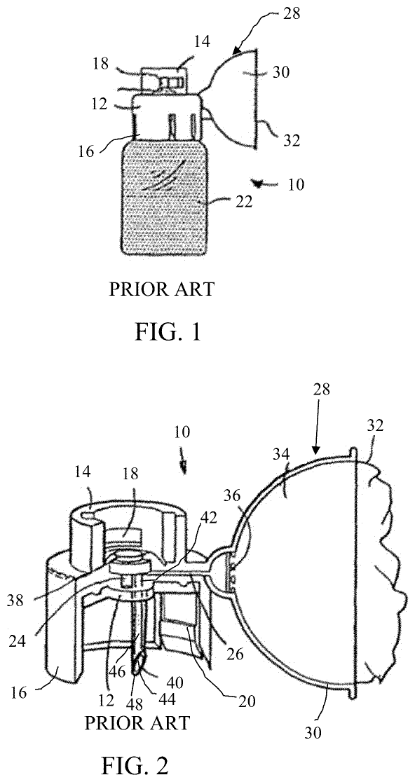

Referring to FIGS. 1 and 2, a conventional vial adapter 10 includes a body 12 having a first end 14 and a second end 16 positioned opposite the first end 14. The first end 14 includes a syringe connection 18 configured to be secured to a syringe adapter (not shown) or a syringe. The connection 18 may be a bayonet-style connection, although other suitable connection arrangements may be provided. The second end 16 includes a vial connection 20 configured to secure the vial adapter 10 to a vial 22. More specifically, the vial connection 20 may snap under the head of the vial 22 when the vial adapter 10 is pushed onto the vial 22 to form a semi-permanent or permanent connection between the vial adapter 10 and the vial 22. The body 12 defines a fluid passageway 24 and a vent passageway 26. The vent passageway 26 is in fluid communication with a pressure equalization device 28. The pressure equalization device 28 includes a body 30 and a barrier 32 that defines an interior space 34. The barrier 32 is moveable to change a volume of the interior space 34. A hydrophobic filter 36 may be positioned between the interior space 34 and the vent passageway 26.

The vial adapter 10 includes a membrane 38 that covers one end of the fluid passageway 24. The membrane 38 of the vial adapter 10 is configured to engage with a corresponding membrane of a syringe adapter (not shown) or other component to facilitate the closed transfer of fluids between the vial 22 and a syringe. The vial adapter 10 includes a cannula 40 secured to the body 12 and in fluid communication with the vent passageway 26. The cannula 40 has an open first end 42 and an open second end 44, with a passageway 46 extending between the open first end 42 and the open second end 44. The open second end 44 includes a piercing tip 48 that is configured to pierce and penetrate a closure or stopper of the vial 22.

Referring again to FIGS. 1 and 2, in use, the vial adapter 10 is pressed onto the vial 22 and the vial connection 20 secures the vial adapter 10 to the vial 22. The cannula 40 of the vial adapter 10 pierces the stopper of the vial 22 such that the cannula 40 is in fluid communication with the vial 22. A syringe adapter (not shown) is connected to the vial adapter 10 using the syringe connection 18, with a needle or cannula of the syringe adapter piercing the membrane 38 and extending through the fluid passageway 24 and into the vial 22 to place the syringe adapter in fluid communication with the vial 22. A diluent or other fluid may be delivered to the vial 22 via the syringe adapter to reconstitute a medicament within the vial 22. When the fluid is delivered or injected into the vial 22, air is displaced by the fluid and travels through the open second end 44 of the cannula 40, through the passageway 46 of the cannula 40, through the vent passageway 26, and into the interior space 34 of the pressure equalization device 28 to cause the barrier 32 to expand to accommodate the air displaced by the fluid within the vial 22. Alternatively, air may first be injected into the vial 22 to expand the barrier 32 of the pressure equalization device 28 such that when liquid is withdrawn from the vial 22, the air within the pressure equalization device 28 is pulled into the vial 22 to prevent a vacuum from being created within the vial 22. As noted above, the piercing of the stopper of the vial 22 by the cannula 40 can sometimes cause coring of the stopper, which can lead to contamination of the medicament or block the vent passageway 26 thereby preventing the pressure equalization device 28 from functioning properly.

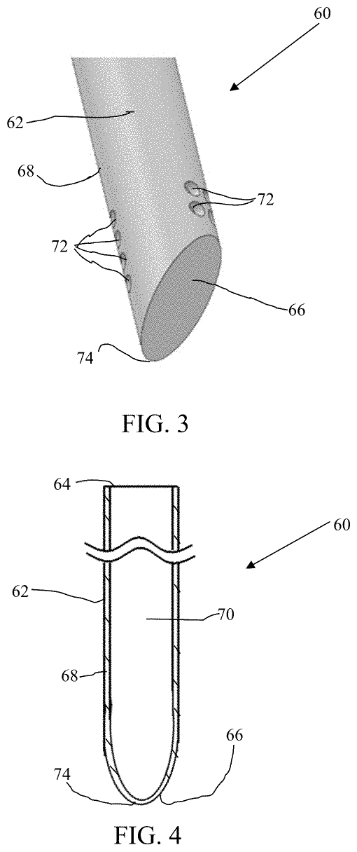

Referring to FIGS. 3 and 4, according to one aspect or embodiment of the present application, a cannula 60 for use in connection with a vial adapter 10 includes a body 62 having a first end 64, a second end 66 positioned opposite the first end 64, and a sidewall 68 extending between the first end 64 and the second end 66. The body 62 defines a central passageway 70 extending from the first end 64 to the second end 66 of the body 62. The body 62 also defines an opening 72 extending through the sidewall 68 of the body 62. The opening 72 is in fluid communication with the central passageway 70. The second end 66 of the body 62 is closed.

In one aspect or embodiment, the cannula 60 replaces the cannula 40 of the vial adapter 10 shown in FIGS. 1 and 2 and operates in the same manner as the vial adapter 10 discussed above. The opening 72 in the sidewall 68 of the cannula 60, however, is in fluid communication with the vial 22 and allows for the transfer of air between the vial 22 and the pressure equalization device 28 rather than the open second end 44 as with the cannula 40 shown in FIGS. 1 and 2. In one aspect or embodiment, the vial adapter 10 is the BD PhaSeal™ drug vial access device commercially available from Becton, Dickinson and Company.

As shown in FIG. 3, the opening 72 may be a plurality of openings 72. The plurality of openings 72 may be arranged in a pattern, such as columns and rows. In one aspect or embodiment, the plurality of openings 72 are sized, shaped, and positioned to optimize the function of the pressure equalization device 28. In one aspect or embodiment, the total opening area of the one or more openings 72 is equal to the opening area at the open second end 44 of the cannula 40 shown in FIGS. 1 and 2. The one or more openings 72 are circular, although other suitable shapes may be utilized.

Referring again to FIGS. 3 and 4, the second end 66 of the body 62 includes a piercing tip 74 configured to pierce a stopper of the vial 22. The second end 66 of the body 62 is beveled, although other suitable arrangements may be utilized.

During use of the cannula 60, as the vial adapter 10 is pushed onto the vial 22, the piercing tip 74 of the cannula 60 pierces and extends through the stopper of the vial 22 such that the one or more openings 72 are in fluid communication with the vial 22. Due to the second end 66 of the cannula 60 being closed, coring or fragmentation of the stopper as the cannula pierces the stopper is eliminated or greatly reduced. In one aspect or embodiment, the cannula 60 functions to allow the passage of air between the vial 22 and the pressure equalization device 28 in the same manner as described above in connection with FIGS. 1 and 2.

While this disclosure has been described as having exemplary designs, the present disclosure can be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims. To the extent possible, one or more features of any aspect or embodiment discussed above can be combined with one or more features of any other aspect or embodiment.

What is claimed is:

1. A cannula for a vial adapter comprising a pressure equalization device, the cannula comprising:
a body having a first end, a second end positioned opposite the first end, and a sidewall extending between the first end and the second end, the body defining a central passageway extending from the first end to the second end of the body, the body defining an opening extending through the sidewall of the body, the opening is in fluid communication with the central passageway, wherein the second end of the body is closed.

2. The cannula of claim 1, wherein the opening comprises a plurality of openings.

3. The cannula of claim 2, wherein the plurality of openings are arranged in a pattern.

4. The cannula of claim 3, wherein the plurality of openings are arranged in columns and rows.

5. The cannula of claim 1, wherein the opening is circular.

6. The cannula of claim 1, wherein the second end of the body comprises a piercing tip configured to pierce a stopper of a vial.

7. The cannula of claim 1, wherein the second end of the body is beveled.

8. A vial adapter comprising:
a body comprising a vent passageway;
a pressure equalization device in fluid communication with the vent passageway; and
the cannula of claim 1, wherein the opening and the central passageway of the cannula is in fluid communication with the vent passageway and the pressure equalization device.

9. The vial adapter of claim 8, further comprising a syringe connection at a first end of the body, the syringe connection configured to be secured to a syringe adapter.

10. The vial adapter of claim 8, further comprising a vial connection at a second end of the body, the vial connection configured to be secured to a vial.

11. The vial adapter of claim 8, wherein the body defines a fluid passageway.

12. The vial adapter of claim 11, further comprising a membrane covering an end of the fluid passageway.
